(19) United States
(12) Patent Application Publication
(10) Pub. No.: US 2025/0117925 A1
(43) Pub. Date: Apr. 10, 2025

(54) DEFECT SYNTHESIS AND DETECTION VIA DEFECT GENERATIVE PRE-TRAINED TRANSFORMER FOR SEMICONDUCTOR APPLICATIONS

(71) Applicant: KLA Corporation, Milpitas, CA (US)

(72) Inventors: Jing Zhang, Santa Clara, CA (US); Yang Li, San Jose, CA (US); Yujie Dong, Newark, CA (US); Xiu Zhang, Milpitas, CA (US); Kris Bhaskar, San Jose, CA (US)

(21) Appl. No.: 18/732,473

(22) Filed: Jun. 3, 2024

Related U.S. Application Data
(60) Provisional application No. 63/543,131, filed on Oct. 9, 2023.

(51) Int. Cl. G06T 7/00; G06N 3/0455; G06N 3/0475; G06T 5/60; G06T 11/00

(52) U.S. Cl. CPC G06T 7/001; G06N 3/0455; G06N 3/0475; G06T 5/60; G06T 11/00; G06T 2207/20081; G06T 2207/30148

(57) ABSTRACT

Methods and systems for determining information for a specimen are provided. One system includes a computer subsystem and one or more components executed by the computer subsystem. The one or more components include a pre-trained defect generative pre-trained transformer (DefectGPT) encoder configured for determining information for a specimen based on one or more inputs specific to the specimen. The computer subsystem is configured for inputting the one or more inputs into the pre-trained DefectGPT encoder.

### BACKGROUND OF THE INVENTION

### 1. Field of the Invention

The present invention generally relates to methods and systems for determining information for a specimen. Certain embodiments relate to methods and systems for defect synthesis and detection via defect generative pre-trained transformer for semiconductor applications.

### 2. Description of the Related Art

The following description and examples are not admitted to be prior art by virtue of their inclusion in this section.

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a reticle to a resist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on specimens to drive higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices because smaller defects can cause the devices to fail.

Defect review typically involves re-detecting defects detected as such by an inspection process and generating additional information about the defects at a higher resolution using either a high magnification optical system or a scanning electron microscope (SEM). Defect review is therefore performed at discrete locations on specimens where defects have been detected by inspection. The higher resolution data for the defects generated by defect review is more suitable for determining attributes of the defects such as profile, roughness, more accurate size information, etc. Defects can generally be more accurately classified into defect types based on information determined by defect review compared to inspection.

Metrology processes are also used at various steps during a semiconductor manufacturing process to monitor and control the process. Metrology processes are different than inspection processes in that, unlike inspection processes in which defects are detected on a specimen, metrology processes are used to measure one or more characteristics of the specimen that cannot be determined using currently used inspection tools. For example, metrology processes are used to measure one or more characteristics of a specimen such as a dimension (e.g., line width, thickness, etc.) of features formed on the specimen during a process such that the performance of the process can be determined from the one or more characteristics. In addition, if the one or more characteristics of the specimen are unacceptable (e.g., out of a predetermined range for the characteristic(s)), the measurements of the one or more characteristics of the specimen may be used to alter one or more parameters of the process such that additional specimens manufactured by the process have acceptable characteristic(s).

Metrology processes are also different than defect review processes in that, unlike defect review processes in which defects that are detected by inspection are re-visited in defect review, metrology processes may be performed at locations at which no defect has been detected. In other words, unlike defect review, the locations at which a metrology process is performed on a specimen may be independent of the results of an inspection process performed on the specimen. In particular, the locations at which a metrology process is performed may be selected independently of inspection results. In addition, since locations on the specimen at which metrology is performed may be selected independently of inspection results, unlike defect review in which the locations on the specimen at which defect review is to be performed cannot be determined until the inspection results for the specimen are generated and available for use, the locations at which the metrology process is performed may be determined before an inspection process has been performed on the specimen.

Even after suitable hardware parameters have been established for the yield related processes described above, methods, systems, algorithms, etc. for determining specimen information from the tool output can still be challenging. For example, even the best images that can be generated for a specimen by the best available tool may not be good enough for determining information for the specimen, and some image processing may be needed to determine the information. Other times, it may simply be difficult to determine a suitable method for determining specimen information from specimen images or other tool output.

A great number of methods, algorithms, systems, etc. have therefore been created for determining information for a specimen in the processes described above. A few examples of currently used defect detection methods include computed reference type methods, algorithms available on some currently available tools such as the multiple die auto-thresholding (MDAT) algorithm, in addition to many other currently used image processing techniques. Additional examples of currently used defect detection methods include active learning for defect classifier training, learnable defect detection for semiconductor applications, and unsupervised or self-supervised deep learning (DL) for semiconductor-based applications.

While many of the defect detection methods described above have achieved at least some success in their implementation, many have at least some minor disadvantages or areas for improvement. For example, computed reference methods may be based on a linear combination and cannot approximate higher order (imaging/signal) information, which is crucial for distinguishing weak defect signals from medium/weak noise. In another example, active learning is good for iteratively training DL defect classifiers or detectors. To make these methods work, however, sufficient training samples are required between each training iteration; and the model has to be trained per semiconductor layer or per each process step. In addition, DL or convolutional neural network (CNN) based detectors must generally be trained per semiconductor layer or per each process step. Similarly, unsupervised or self-supervised DL methods must be trained per semiconductor layer or per each process step.

Even when a suitable method for processing the tool output has been found, challenges in generating suitable training data can remain. In one such example, to generate a suitable defect detection method, a relatively large number of defect examples are often needed to select and then train the defect detection method. Those defect examples may be difficult to acquire or generate for a number of reasons such as the relatively limited number of defects on any one specimen, the difficulty and time involved in identifying such defects, and even the time and cost of generating the tool output for such defects.

Some methods and systems have, therefore, been created to synthesize defects that can be used to setup processes such as those described above. Some such methods use machine learning/deep learning (ML/DL) generative models to generate defect-free optical images from design information for a single optical mode. Some other ML/DL generative models have been created that can generate defect-free optical images from design information for multiple optical modes. ML/DL generative models have also been created to generate defect-free optical images from optical images (collected at a given mode) for multiple optical modes. In some situations, computer vision algorithms (e.g., painting, blending, etc.) can generate relatively low quality defect images. In addition, optical simulation can be used to simulate defect images.

The currently available defect synthesis methods have, however, a number of significant disadvantages. For example, the ML/DL generative models created to generate defect-free optical images from design information for a single optical mode can only generate background integrated circuit (IC) patterns for a single optical mode and not defects. In another example, the ML/DL generative models that can generate defect-free optical images from design information for multiple optical modes can only generate background IC patterns for multiple optical modes but not defects in multiple optical mode contexts. In another example, the ML/DL generative models created to generate defect-free optical images from optical images (collected at a given mode) for multiple optical modes can only convert background IC patterns from one optical mode to others but not defects in other optical mode contexts. Computer vision algorithms can be disadvantageous because the generated defects have relatively low quality that are not consistent with the real defect attributes including shape, strength, spread, etc. Furthermore, it is difficult to include process variation, conditions that affect the pattern variation, and systematic and random noise in optical simulation of simulate defect images. In addition, these methods are computationally intensive and therefore impractical for the synthesis of a relatively large number of defects.

Accordingly, it would be advantageous to develop systems and methods for determining information for a specimen that do not have one or more of the disadvantages described above.

### SUMMARY OF THE INVENTION

The following description of various embodiments is not to be construed in any way as limiting the subject matter of the appended claims.

One embodiment relates to a system configured for determining information for a specimen. The system includes a computer subsystem and one or more components executed by the computer subsystem. The one or more components include a pre-trained defect generative pre-trained transformer (DefectGPT) encoder configured for determining information for a specimen based on one or more inputs specific to the specimen. The computer subsystem is configured for inputting the one or more inputs into the pre-trained DefectGPT encoder. The system may be further configured as described herein.

Another embodiment relates to a computer-implemented method for determining information for a specimen. The method includes inputting one or more inputs specific to a specimen into a pre-trained DefectGPT encoder configured for determining information for the specimen based on the one or more inputs. Each of the steps of the method may be performed as described further herein. The method may include any other step(s) of any other method(s) described herein. The method may be performed by any of the systems described herein.

Another embodiment relates to a non-transitory computer-readable medium storing program instructions executable on a computer system for performing a computer-implemented method for determining information for a specimen. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIGS. 1 and 2 are schematic diagrams illustrating side views of embodiments of a system configured as described herein;

FIG. 3 is a flow chart illustrating an embodiment of pre-training a defect generative pre-trained transformer (DefectGPT) model;

FIGS. 4 and 5 are flow charts illustrating an embodiment of defect detection performed via defect prompt with a pre-trained DefectGPT encoder;

FIG. 6 is a block diagram illustrating an embodiment of Network A configured for generating defect signals;

FIG. 7 is a block diagram illustrating an embodiment of Network B configured for generating simulated images without defects;

FIGS. 8 and 9 are block diagrams illustrating embodiments of Network C1 and Network C2, respectively, configured for generating simulated images with defects;

FIG. 10 is a block diagram illustrating an embodiment of Network D configured for generating simulated images with defects using diffusion models; and

FIG. 11 is a block diagram illustrating one embodiment of a non-transitory computer-readable medium storing program instructions for causing a computer system to perform a computer-implemented method described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

In general, the embodiments described herein are configured for determining information for a specimen via defect synthesis and/or defect detection. Defect synthesis is generally defined herein as a process to simulate a defect of interest (DOI) in semiconductor applications for understanding the process condition, process window, and enabling yield improvement for semiconductor fabrication. The embodiments described herein introduce the technology called Defect Generative Pre-Trained Transformer (DefectGPT) for artificial intelligence (AI)-empowered defect synthesis processes, which enables the synthetic defect images targeted for optical inspectors to be well-aligned with process condition, process variation, and defect distribution for a given process wafer. The synthetic defect images can be applied to defect detection in inspection and metrology applications. In addition, the defect detection and defect synthesis methods and systems described herein are all constructed based on a DefectGPT model with different training and inference methods.

In some embodiments, the specimen is a wafer. The wafer may include any wafer known in the semiconductor arts. Although some embodiments may be described herein with respect to a wafer or wafers, the embodiments are not limited in the specimens for which they can be used. For example, the embodiments described herein may be used for specimens such as reticles, flat panels, personal computer (PC) boards, and other semiconductor specimens.

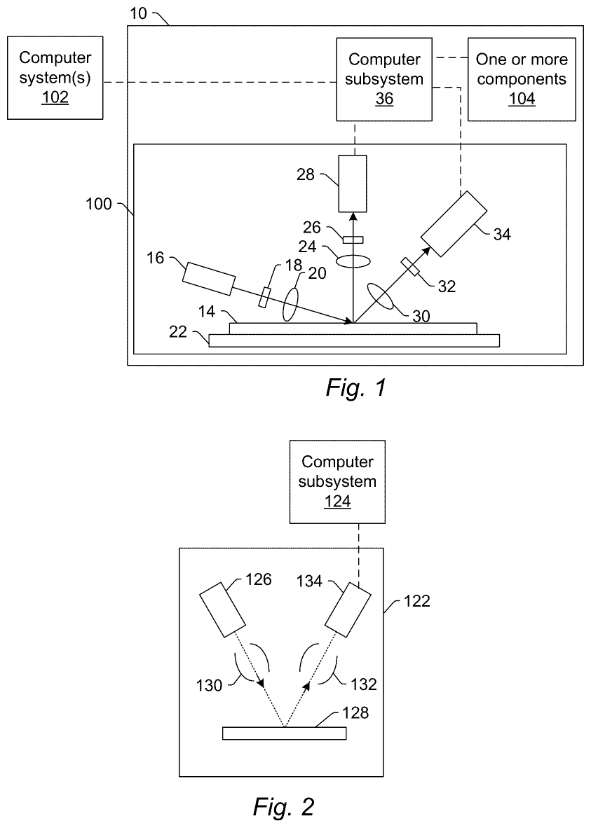

One embodiment of a system configured for determining information for a specimen is shown in FIG. 1. In some embodiments, system 10 includes an inspection subsystem such as inspection subsystem 100. The inspection subsystem includes and/or is coupled to a computer subsystem, e.g., computer subsystem 36 and/or one or more computer systems 102.

In general, the inspection subsystems described herein include at least an energy source and a detector. The energy source is configured to generate energy that is directed to a specimen. The detector is configured to detect energy from the specimen and to generate output responsive to the detected energy.

In a light-based inspection subsystem, the energy directed to the specimen includes light, and the energy detected from the specimen includes light. For example, as shown in FIG. 1, the inspection subsystem includes an illumination subsystem configured to direct light to specimen 14. The illumination subsystem includes at least one light source, e.g., light source 16. The illumination subsystem is configured to direct the light to the specimen at one or more angles of incidence, which may include one or more oblique angles and/or one or more normal angles. For example, as shown in FIG. 1, light from light source 16 is directed through optical element 18 and then lens 20 to specimen 14 at an oblique angle of incidence. The oblique angle of incidence may include any suitable oblique angle of incidence, which may vary depending on, for instance, characteristics of the specimen and the defects to be detected on the specimen.

The illumination subsystem may be configured to direct the light to the specimen at different angles of incidence. For example, the inspection subsystem may be configured to alter one or more parameters of one or more elements of the illumination subsystem such that the light can be directed to the specimen at an angle of incidence that is different than that shown in FIG. 1. In one such example, the inspection subsystem may be configured to move light source 16, optical element 18, and lens 20 such that the light is directed to the specimen at a different oblique angle of incidence or a normal (or near normal) angle of incidence. The illumination subsystem may have any other suitable configuration known in the art for directing the light to the specimen at one or more angles of incidence sequentially or simultaneously.

The illumination subsystem may also be configured to direct light with different characteristics to the specimen. For example, optical element 18 may be configured as a spectral filter and the properties of the spectral filter can be changed in a variety of different ways (e.g., by swapping out one spectral filter with another) such that different wavelengths of light can be directed to the specimen at different times.

Light source 16 may include a broadband plasma (BBP) light source. In this manner, the light generated by the light source and directed to the specimen may include broadband light. However, the light source may include any other suitable light source such as any suitable laser known in the art configured to generate light at any suitable wavelength(s). In addition, the laser may be configured to generate light that is monochromatic or nearly-monochromatic. In this manner, the laser may be a narrowband laser. The light source may also include a polychromatic light source that generates light at multiple discrete wavelengths or wavebands.

Light from optical element 18 may be focused onto specimen 14 by lens 20. Although lens 20 is shown in FIG. 1 as a single refractive optical element, in practice, lens 20 may include a number of refractive and/or reflective optical elements that in combination focus the light from the optical element to the specimen. The illumination subsystem shown in FIG. 1 and described herein may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more elements of the illumination subsystem based on the type of illumination to be used for inspection.

The inspection subsystem may also include a scanning subsystem configured to change the position on the specimen to which the light is directed and from which the light is detected and possibly to cause the light to be scanned over the specimen. For example, the inspection subsystem may include stage 22 on which specimen 14 is disposed during inspection. The scanning subsystem may include any suitable mechanical and/or robotic assembly (that includes stage 22) that can be configured to move the specimen such that the light can be directed to and detected from different positions on the specimen. In addition, or alternatively, the inspection subsystem may be configured such that one or more optical elements of the inspection subsystem perform some scanning of the light over the specimen such that the light can be directed to and detected from different positions on the specimen. The light may be scanned over the specimen in any suitable fashion such as in a serpentine-like path or in a spiral path.

The inspection subsystem further includes one or more detection channels. At least one of the detection channel(s) includes a detector configured to detect light from the specimen due to illumination of the specimen by the system and to generate output responsive to the detected light. The inspection subsystem shown in FIG. 1 includes two detection channels, one formed by collector 24, element 26, and detector 28 and another formed by collector 30, element 32, and detector 34. The two detection channels are configured to collect and detect light at different angles of collection. In some instances, both detection channels are configured to detect scattered light, and the detection channels are configured to detect light that is scattered at different angles from the specimen. However, one or more of the detection channels may be configured to detect another type of light from the specimen (e.g., reflected light).

In FIG. 1, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 30, element 32, and detector 34 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 1 shows an embodiment of the inspection subsystem that includes two detection channels, the inspection subsystem may include a different number of detection channels (e.g., only one detection channel or two or more detection channels). The detection channel formed by collector 30, element 32, and detector 34 may form one side channel as described above, and the inspection subsystem may include an additional detection channel (not shown) formed as another side channel that is positioned on the opposite side of the plane of incidence. Therefore, the inspection subsystem may include the detection channel that includes collector 24, element 26, and detector 28 and that is centered in the plane of incidence and configured to collect and detect light at scattering angle(s) that are at or close to normal to the specimen surface. This detection channel may therefore be commonly referred to as a “top” channel, and the inspection subsystem may also include two or more side channels configured as described above. As such, the inspection subsystem may include at least three channels (i.e., one top channel and two side channels), and each of the at least three channels is configured to collect light at different scattering angles than each of the other collectors.

As described further above, one or more of the detection channels may be configured to detect scattered light. Therefore, the inspection subsystem shown in FIG. 1 may be configured for dark field (DF) inspection. However, the inspection subsystem may also or alternatively include detection channel(s) that are configured for bright field (BF) inspection. Therefore, the inspection subsystems described herein may be configured for only DF, only BF, or both DF and BF inspection. Although each of the collectors are shown in FIG. 1 as single refractive optical elements, each of the collectors may include refractive optical element(s) and/or reflective optical element(s).

The one or more detection channels may include any suitable detectors known in the art such as photo-multiplier tubes (PMTs), charge coupled devices (CCDs), and time delay integration (TDI) cameras. The detectors may also include non-imaging detectors or imaging detectors. If the detectors are non-imaging detectors, each of the detectors may be configured to detect certain characteristics of the scattered light such as intensity but may not be configured to detect such characteristics as a function of position within the imaging plane. As such, the output that is generated by each of the detectors in each of the detection channels may be signals or data, but not image signals or image data. In such instances, a computer subsystem may be configured to generate images of the specimen from the non-imaging output of the detectors. However, in other instances, the detectors may be configured as imaging detectors that are configured to generate imaging signals or image data. Therefore, the inspection subsystem may be configured to generate images in a number of ways.

Computer subsystem 36 may be coupled to the detectors of the inspection subsystem in any suitable manner (e.g., via one or more transmission media, which may include “wired” and/or “wireless” transmission media) such that the computer subsystem can receive the output generated by the detectors. Computer subsystem 36 may be configured to perform a number of functions using the output of the detectors as described further herein. Computer subsystem 36 may be further configured as described herein.

Computer subsystem 36 (as well as other computer subsystems described herein) may also be referred to herein as computer system(s). Each of the computer subsystem(s) or system(s) described herein may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool.

If the system includes more than one computer subsystem, then the different computer subsystems may be coupled to each other such that images, data, information, instructions, etc. can be sent between the computer subsystems. For example, computer subsystem 36 may be coupled to computer system(s) 102 as shown by the dashed line in FIG. 1 by any suitable transmission media, which may include any suitable wired and/or wireless transmission media known in the art. Two or more of such computer subsystems may also be effectively coupled by a shared computer-readable storage medium (not shown).

In an electron beam inspection subsystem, the energy directed to the specimen includes electrons, and the energy detected from the specimen includes electrons. In one such embodiment shown in FIG. 2, the inspection subsystem includes electron column 122, and the system includes computer subsystem 124 coupled to the inspection subsystem. Computer subsystem 124 may be configured as described above. In addition, such an inspection subsystem may be coupled to another one or more computer subsystems in the same manner described above and shown in FIG. 1.

As also shown in FIG. 2, the electron column includes electron beam source 126 configured to generate electrons that are focused to specimen 128 by one or more elements 130. The electron beam source may include, for example, a cathode source or emitter tip, and one or more elements 130 may include, for example, a gun lens, an anode, a beam limiting aperture, a gate valve, a beam current selection aperture, an objective lens, and a scanning subsystem, all of which may include any such suitable elements known in the art.

Electrons returned from the specimen (e.g., secondary electrons) may be focused by one or more elements 132 to detector 134. One or more elements 132 may include, for example, a scanning subsystem, which may be the same scanning subsystem included in element(s) 130.

The electron column may include any other suitable elements known in the art. In addition, the electron column may be further configured as described in U.S. Pat. No. 8,664,594 issued Apr. 4, 2014 to Jiang et al., U.S. Pat. No. 8,692,204 issued Apr. 8, 2014 to Kojima et al., U.S. Pat. No. 8,698,093 issued Apr. 15, 2014 to Gubbens et al., and U.S. Pat. No. 8,716,662 issued May 6, 2014 to MacDonald et al., which are incorporated by reference as if fully set forth herein.

Although the electron column is shown in FIG. 2 as being configured such that the electrons are directed to the specimen at an oblique angle of incidence and are scattered from the specimen at another oblique angle, the electron beam may be directed to and scattered from the specimen at any suitable angles. In addition, the electron beam inspection subsystem may be configured to use multiple modes to generate output for the specimen as described further herein (e.g., with different illumination angles, collection angles, etc.). The multiple modes of the electron beam inspection subsystem may be different in any output generation parameters of the inspection subsystem.

Computer subsystem 124 may be coupled to detector 134 as described above. The detector may detect electrons returned from the surface of the specimen thereby forming electron beam images of (or other output for) the specimen. The electron beam images may include any suitable electron beam images. Computer subsystem 124 may be configured to perform any step(s) described herein. A system that includes the inspection subsystem shown in FIG. 2 may be further configured as described herein.

FIGS. 1 and 2 are provided herein to generally illustrate configurations of an inspection subsystem that may be included in the system embodiments described herein. Obviously, the inspection subsystem configurations described herein may be altered to optimize the performance of the inspection subsystem as is normally performed when designing a commercial inspection system. In addition, the systems described herein may be implemented using an existing inspection system (e.g., by adding functionality described herein to an existing inspection system) such as the tools that are commercially available from KLA Corp., Milpitas, Calif. For some such systems, the methods described herein may be provided as optional functionality of the inspection system (e.g., in addition to other functionality of the inspection system). Alternatively, the inspection system described herein may be designed “from scratch” to provide a completely new inspection system.

Although the inspection subsystem is described above as being a light or electron beam inspection subsystem, the inspection subsystem may be an ion beam inspection subsystem. Such an inspection subsystem may be configured as shown in FIG. 2 except that the electron beam source may be replaced with any suitable ion beam source known in the art. In addition, the inspection subsystem may include any other suitable ion beam system such as those included in commercially available focused ion beam (FIB) systems, helium ion microscopy (HIM) systems, and secondary ion mass spectroscopy (SIMS) systems.

The inspection subsystem may be configured to generate output, e.g., images, of the specimen with multiple modes. In general, a “mode” is defined by the values of parameters of the inspection subsystem used for generating images of a specimen (or the output used to generate images of the specimen). Therefore, modes may be different in the values for at least one of the parameters of the inspection subsystem (other than position on the specimen at which the output is generated). For example, the modes may be different in any one or more alterable parameters (e.g., illumination polarization(s), angle(s), wavelength(s), etc., detection polarization(s), angle(s), wavelength(s), etc.) of the inspection subsystem. The inspection subsystem may be configured to scan the specimen with the different modes in the same scan or different scans, e.g., depending on the capability of using multiple modes to scan the specimen at the same time.

In a similar manner, the electron beam subsystem may be configured to generate images with two or more modes, which can be defined by the values of parameters of the electron beam subsystem used for generating images for a specimen. Therefore, modes may be different in the values for at least one of the electron beam parameters of the electron beam subsystem. For example, different modes may use different angles of incidence for illumination.

In another embodiment, the system includes a metrology subsystem. In a further embodiment, the system includes a defect review subsystem. For example, the embodiments of the inspection subsystem shown in FIGS. 1 and 2 may be modified in one or more parameters to provide different imaging capability depending on the application for which it will be used. In one such example, the inspection subsystem may be configured to have a higher resolution if it is to be used for metrology rather than for inspection. In other words, the embodiments of the inspection subsystem shown in FIGS. 1 and 2 describe some general and various configurations for an imaging subsystem that can be tailored in a number of manners that will be obvious to one skilled in the art to produce systems having different imaging capabilities that are more or less suitable for different applications.

In this manner, the imaging subsystem may be configured for generating output that is suitable for re-detecting defects on the specimen in the case of a defect review system and for measuring one or more characteristics of the specimen in the case of a metrology system. In a defect review system embodiment, computer subsystem 124 shown in FIG. 2 may be configured for re-detecting defects on specimen 128 by applying a defect re-detection method to the output generated by detector 134 and possibly determining additional information for the re-detected defects using the output generated by the detector. In a metrology system embodiment, computer subsystem 36 shown in FIG. 1 may be configured for determining one or more characteristics of specimen 14 using the output generated by detectors 28 and/or 34.

As noted above, the inspection subsystem is configured for scanning energy (e.g., light, electrons, etc.) over a physical version of the specimen thereby generating output for the physical version of the specimen. In this manner, the inspection subsystem may be configured as an “actual” subsystem, rather than a “virtual” subsystem. However, a storage medium (not shown) and computer subsystem(s) 102 shown in FIG. 1 may be configured as a “virtual” system. In particular, the storage medium and the computer subsystem(s) may be configured as a “virtual” inspection system as described in commonly assigned U.S. Pat. No. 8,126,255 issued on Feb. 28, 2012 to Bhaskar et al. and U.S. Pat. No. 9,222,895 issued on Dec. 29, 2015 to Duffy et al., which are incorporated by reference as if fully set forth herein. The embodiments described herein may be further configured as described in these patents.

The system includes a computer subsystem, which may include any configuration of any of the computer subsystem(s) or system(s) described above, and one or more components executed by the computer subsystem. For example, as shown in FIG. 1, the system may include computer subsystem 36 and one or more components 104 executed by the computer subsystem. The one or more components include a pre-trained DefectGPT encoder configured for determining information for a specimen based on one or more inputs specific to the specimen. The computer subsystem is configured for inputting the one or more inputs into the pre-trained DefectGPT encoder, which may be performed in any suitable manner known in the art.

The input(s) may include a variety of different inputs, which as described further herein is one of the advantages of the embodiments described herein. In some embodiments, the computer subsystem may generate one or more of the inputs, but more generally, the computer subsystem may acquire one or more of the inputs, e.g., from an inspection recipe, from a storage medium, from one or more other systems and/or methods, from a user, etc. For example, inputs such as DOI location hints and DOI descriptors may be acquired from user input or from an inspection recipe, previously generate inspection results. and the like. Inputs such as optical modes and process parameters may be acquired from an inspection recipe and a process recipe, respectively, that are stored in some storage medium. Other inputs like design images may be acquired from a storage medium in which the design is stored and/or in which design images that have been generated from design data are stored. Additional inputs described herein may be acquired in similar manners.

In one embodiment, the computer subsystem is configured for detecting defects on the specimen based on the information determined for the specimen by the pre-trained DefectGPT encoder. For example, in some embodiments described herein, the pre-trained DefectGPT encoder may be used for detecting defects on the specimen. In other embodiments, the pre-trained DefectGPT encoder may be configured for generating synthetic information for the specimen or defects that may be present on the specimen.

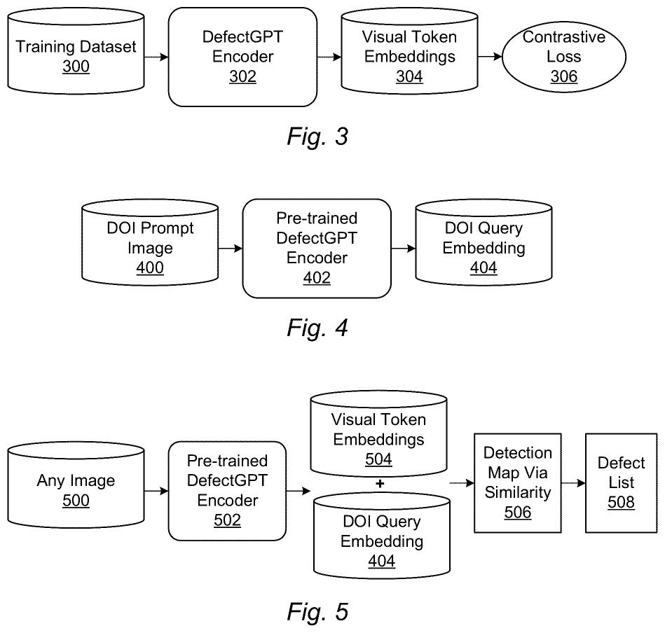

In another embodiment, the computer subsystem is configured for pre-training an initial DefectGPT encoder thereby producing the pre-trained DefectGPT encoder, and the pre-training is performed with a training dataset that includes images specific to the specimen and images that are unrelated to determining the information for the specimen based on the one or more inputs. The unrelated images are optional. For example, in a further embodiment, the computer subsystem is configured for pre-training an initial DefectGPT encoder thereby producing the pre-trained DefectGPT encoder, and the pre-training is performed with a training dataset comprising only images specific to the specimen. In a defect detection construction, as shown in FIG. 3, for example, pre-training a DefectGPT model may include inputting training dataset 300 into DefectGPT encoder 302. The training dataset may include only target semiconductor images (i.e., the images specific to the specimen) or the target semiconductor images and optional out-of-domain images (i.e., the images that are unrelated to determining the information for the specimen). In one such example, when the application is scanning electron microscope (SEM) defect detection, the target semiconductor images are SEM images, and the optional out-of-domain images may include other semiconductor images, nature images, or other application domain images.

In an additional embodiment, the computer subsystem is configured for pre-training an initial DefectGPT encoder thereby producing the pre-trained DefectGPT encoder, and the initial DefectGPT encoder is configured for encoding input images into visual token embeddings 304. For example, the DefectGPT encoder takes the inputs of an image with dimensions (Height, Width, Channel) and encodes it into the visual token embedding with size (H/s, W/s, Size of embedding), where s is the stride ranging between [1, min(H, W)].

In a further embodiment, the computer subsystem is configured for pre-training an initial DefectGPT encoder in a self-supervised manner thereby producing the pre-trained DefectGPT encoder. For example, contrastive loss 306 or equivalent may be used to pre-train the model in a self-supervised manner.

Defect detection may then be performed via defect prompt. In some embodiments, the pre-trained DefectGPT encoder is configured for determining a DOI query embedding based on one or more input DOI prompt images. As shown in FIG. 4, for example, pre-trained DefectGPT encoder 402 is configured for determining DOI query embedding 404 based on DOI prompt image 400. The DOI prompt image may be a patch image with size (N*s, N*s) containing a defect or partial defect, where N is any integer (>=1) and s is the stride used in pre-training. The DOI prompt image may be acquired in any suitable manner known in the art, e.g., using a ground truth method or a known, good defect detection method. When there are more than one input DOI prompt images for generating query embeddings, each of the input DOI prompt images may be used to generate a set of query embeddings, and then a combined query embedding may be computed by averaging them or weighted averaging of them. In this manner, different input DOI prompt images for different instances of the same kind of DOI or different input DOI prompt images for the same instance of a DOI may be used to generating a combined query image. Generating a combined query embedding in this manner may increase the robustness of the pre-trained DefectGPT encoder.

In one such embodiment, the one or more inputs include a target image for defect detection, determining the information includes determining a visual token embedding for the target image, and the computer subsystem is configured for determining a measure of similarity between the DOI query embedding and the visual token embedding and determining if a defect is present in the target image based on the determined measure of similarity. For example, as shown in FIG. 5, any image 500, which may be any target image for defect detection in arbitrary size, may be input to pre-trained DefectGPT encoder 502, which generates visual token embeddings 504. The computer subsystem may then determine a measure of similarity between target visual token embeddings 504 and prompt DOI query embedding 404 and generate a detection map via similarity 506, which may include information for any locations on the specimen or in the images that have a measure of similarity between the visual token embeddings and DOI query embedding above some predetermined threshold.

The measure of similarity may include any qualitative or quantitative measure that can be used to express how similar the different embeddings are and may be determined by the computer subsystem in any suitable manner known in the art. The predetermined threshold that separates embeddings that are similar enough from those that are not may be determined in any suitable manner, e.g., based on input from a user.

The computer subsystem may also generate other inspection results from the detection map such as defect list 508, which may include any information for the locations on the specimen or in the images at which a defect has been detected via the similarity measure.

The embodiments described herein may therefore use the visual token embeddings and prompt DOI query embeddings for defect detection. In this manner, the defect detection described herein is performed in latent space rather than image space. In other words, unlike most other defect detection that involves comparing the actual images themselves, e.g., to generate a difference image that is then examined for defects, the embodiments described herein determine embeddings from the different images and then compare the embeddings, but not the images. Performing defect detection in this manner will most likely make the process simpler and more accurate, since the embeddings can be determined substantially accurately via the embodiments described herein and comparing the embeddings rather than images will be simpler and should yield more accurate results.

The embodiments described herein are also advantageous because by determining the prompt DOI query embeddings as described herein, the defect detection may be used to only find similar DOIs on the test specimen. In other words, nuisances and other defects not of interest may not be found by this defect detection, thereby increasing the accuracy of the inspection and reducing the nuisance filtering that may still be performed on these results (or even eliminating such filtering entirely) compared to normally performed nuisance filtering.

Although the embodiments are described herein with respect to one prompt DOI query embedding, the embodiments may generate multiple prompt DOI query embeddings (one for each of multiple, different DOIs) and compare any one visual token embedding to the multiple prompt DOI query embeddings to see if any one of the DOIs are present in an image. Furthermore, although the embodiments are described herein with respect to positive prompt query embeddings, the prompt query embeddings may also be generated and used for identifying defects not of interest and/or nuisance or noise on the specimen. In other words, prompt query embeddings may be generated for either or both of positive and negative examples of events that may be present on the specimen even though generally, the user will only be interested in the positive examples of events (e.g., DOI(s)).

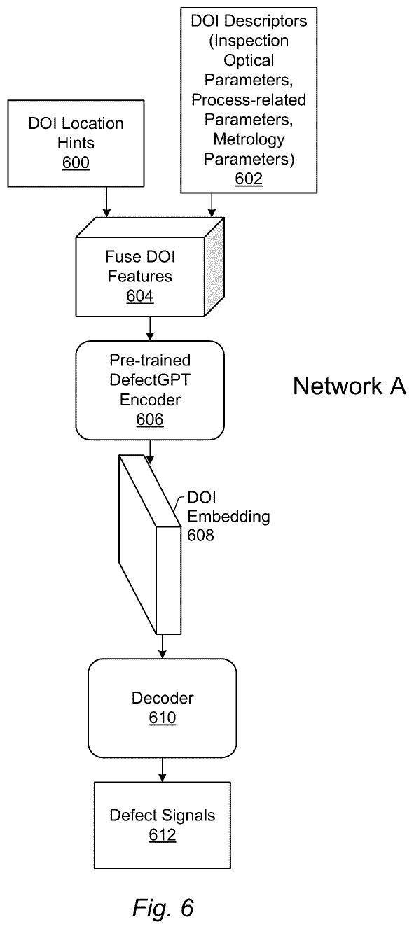

In general, the defect synthesis embodiments presented herein can be constructed through one or more major steps described herein and shown in FIGS. 6-10 and named as Networks A, B, C1, C2, and D, respectively. All the encoders in Networks A, B, C1, C2, and D use a pre-trained DefectGPT encoder. In addition, in these embodiments, the one or more components include a decoder configured for generating synthesized defect information from the information determined for the specimen by the pre-trained DefectGPT encoder. The decoders may be configured as described further herein.

Network A shown in FIG. 6 is configured to generate defect signal images for Network C1 and/or Network C2. As shown in FIG. 6, in some embodiments, the computer subsystem is configured for generating fused DOI features 604 from DOI location hints 600 and DOI descriptors 602, the one or more inputs to pre-trained DefectGPT encoder 606 include the fused DOI features, the determined information includes DOI embedding 608, and the one or more components include decoder 610 configured for generating defect signal images 612 from the DOI embedding. In this manner, inputs including DOI location hints and DOI descriptors (inspection optical parameters, process-related parameters, metrology parameters, etc.) are fused into the DOI features. The fused DOI features are converted into DOI latent after being processed by pre-trained DefectGPT encoder 606. The defect signals are then generated by the decoder.

The inspection optical parameters may include optical conditions of the inspection tool. For example, on some inspection tools, these parameters may include the optical wavelength band, focus condition, aperture, etc. Each of them may be a single parameter for one input, for example, wavelength=200 nm, focus=0 nm, aperture=BF, etc. The process-related parameters are the process parameters for the process tool(s) that is/are used to manufacture the wafer, for example, lithography focus and exposure, etch tool conditions, etc. The metrology parameters may include parameters measured by a metrology tool at the current step or prior process step on key wafer metrology measurements, like film thickness, etc.

The fusion that is performed in step 604 may be performed as follows and in similar ways in other networks described herein (albeit with different inputs). DOI location hints 600 may be a spatial matrix with size (Height, Width, 1), and each of the elements has a value of 0 or 1, with 0 representing non-DOI locations and 1 representing DOI locations. Optical parameters in DOI descriptors 602 is a spatial matrix with the same H and W, but possibly with a different number of channels (i.e., size of (H, W, C)). The C value represents the number of optical parameters. For example, if we consider three optical parameters, wavelength, aperture, and focus, the matrix will be (H, W, 3). All the elements in one parameter channel will have the same encoded value to represent the choice of the parameter. Similar constructions may be used for process-related parameters in DOI descriptors 602 with a matrix size of (H, W, C′), where C′ is the number of process parameters. Metrology parameters is a spatial matrix with size (H, W, C″*number of layers). Each element in the matrix represents a metrology measurement at spatial location H and W for the C″-th parameter at the chosen layer. The fusion operation is to fuse the four matrices into one matrix, possibly via concatenation:

$$concat : ( H , W , 1 ) + ( H , W , C ) + ( H , W , {C}^{′} ) + ( H , W , {C}^{″} * n ) \text{=>} ( H , W , 1 + C + {C}^{′} + {C}^{″} * n )$$

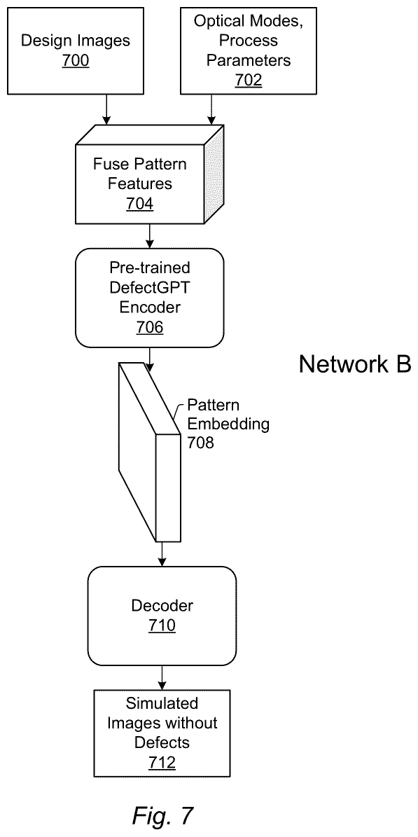

Network B is configured to generate simulated images without defects for Network C1 and Network C2. As shown in FIG. 7, in a further embodiment, the computer subsystem is configured for generating fused pattern features 704 from design images 700 for the specimen, optical mode information, and process parameter information (Optical Modes, Process Parameters 702), the one or more inputs to pre-trained DefectGPT encoder 706 include the fused patterned features, the determined information includes pattern embedding 708, and the one or more components include a decoder 710 configured for generating simulated images 712 of the specimen without defects from the pattern embedding. In this manner, the inputs including design images, optical modes, and process parameters are fused into pattern features, which may be performed as described further herein. The pattern features are converted into pattern latent after being processed by pre-trained DefectGPT encoder 706. The simulated images without defects are generated by the decoder.

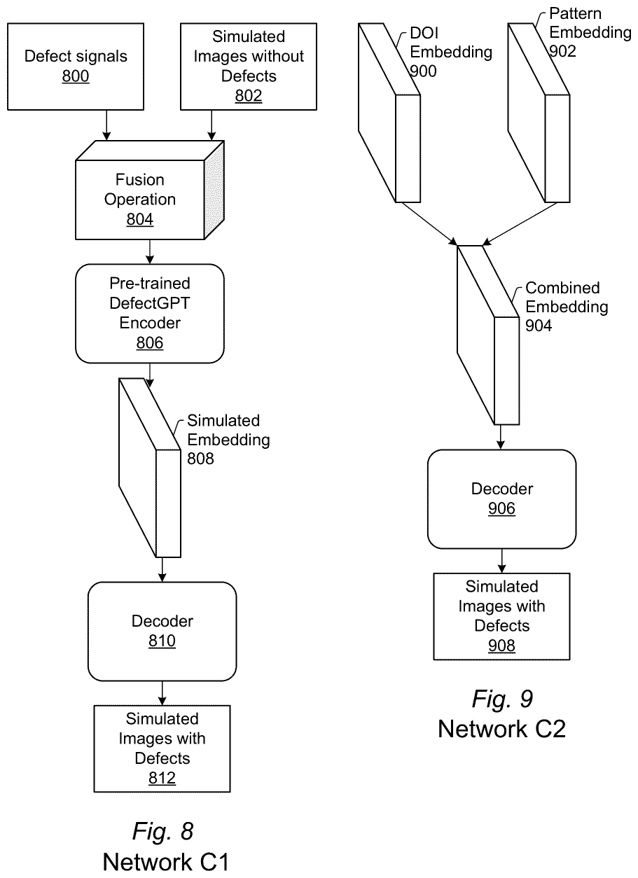

Network C1 is configured for generating simulated images with defects. As shown in FIG. 8, in another embodiment, the computer subsystem is configured for generating fused input (via fusion operation 804) from defect signal images 800 for the specimen and simulated images without defects 802 for the specimen, the one or more inputs to pre-trained DefectGPT encoder 806 include the fused input (generated by fusion operation 804), the determined information includes simulated embedding 808, and the one or more components include a decoder 810 configured for generating simulated images with defects 812 on the specimen from the simulated embedding. In this manner, the inputs including defect signals (generated by Network A) and simulated images without defects (from Network B) are fused. Fused features are converted into simulated latent after being processed by pre-trained DefectGPT encoder 806. The simulated images with defects are generated by the decoder.

Network C2 is also configured to generate simulated images with defects. As shown in FIG. 9, in one embodiment, the determined information includes DOI embedding 900 (from Network A), pattern embedding 902 (from Network B), and combined embedding 904 generated from the DOI embedding and the pattern embedding, and the one or more components include a decoder 906 configured for generating simulated images with defects 908 on the specimen from the combined embedding. In this embodiment, then, inputs including DOI latent (e.g., generated by pre-trained DefectGPT encoder 606 in Network A) and pattern latent (e.g., generated by pre-trained DefectGPT encoder 706 in Network B) are combined. The simulated images with defects are then generated by the decoder.

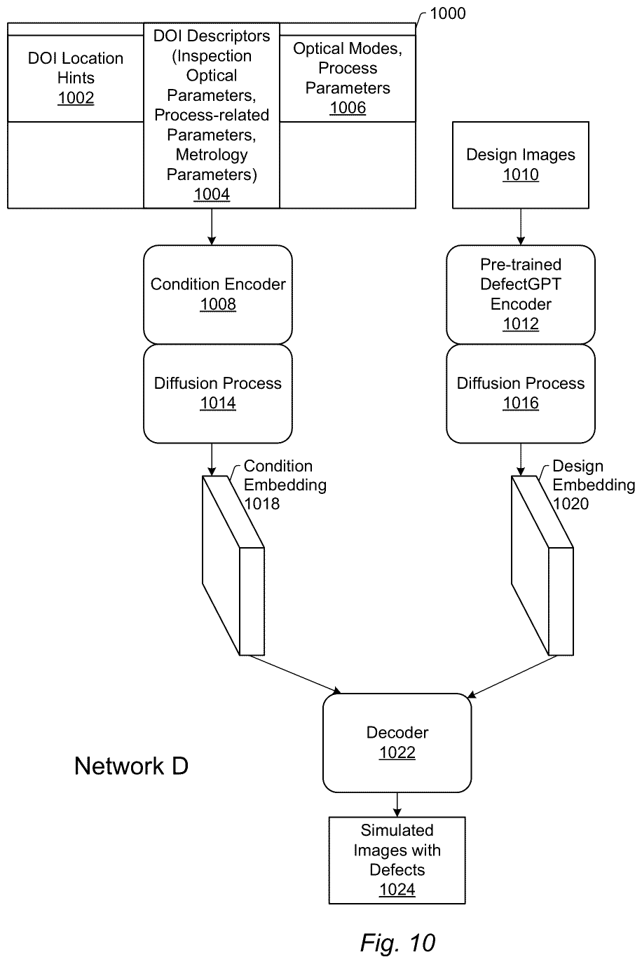

An optimized construction using diffusion process/models is shown in FIG. 10 and named Network D. Network D is configured for generating simulated images with defects. In this embodiment, the one or more inputs include design images 1010 for the specimen, and the one or more components include a first diffusion process model 1016 configured for generating design embedding 1020 from the information determined for the specimen by the pre-trained DefectGPT encoder 1012. In this manner, design images are processed by pre-trained DefectGPT encoder 1012.

In one such embodiment, the one or more components include a condition encoder 1008 configured for determining additional information for the specimen from input 1000 that includes DOI location hints 1002, DOI descriptors 1004, optical mode information, and process parameter information (Optical Modes/Process Parameters 1006), and the one or more components include a second diffusion process model 1014 configured for generating condition embedding 1018 from the additional information. In this manner, inputs 1000 including DOI location hints and DOI descriptors (Inspection Optical Parameters, Process-related Parameters, Metrology Parameters, etc.), and optical modes and process parameters are processed by condition encoder 1008. In addition, both the condition encoder and the pre-trained DefectGPT encoder are followed by diffusion process/models. The diffusion process/models may have any suitable configuration known in the art.

In another such embodiment, the one or more components include a decoder 1022 configured for generating simulated images with defects 1024 for the specimen based on the design embedding 1020 and the condition embedding 1018. In this manner, the simulated images with defects are generated by the decoder.

In one embodiment, the pre-trained DefectGPT encoder is configured as a vision transformer (ViT) or a Swin transformer. In addition, the pre-trained DefectGPT encoder may be any transformer-based model including, but not limited to, a transformer, ViT, hybrid convolutional neural network (CNN) with transformer/ViT, and Swin Transformer. The ViT may be configured as described by Dosovitskiy et al., “An Image is Worth 16×16 Words: Transformer for Image Recognition at Scale,” published as a conference paper at ICLR 2021, arXiv: 2010.11929v2, Jun. 3, 2021, 22 pages, which is incorporated by reference as if fully set forth herein. The Swin transformer may be configured as described by Liu et al., “Swin Transformer: Hierarchical Vision Transformer using Shifted Windows,” arXiv: 2103.14030v2, Aug. 17, 2021, 14 pages, which is incorporated by reference as if fully set forth herein. The pre-trained DefectGPT encoders described herein may be further configured as described in these references.

In another embodiment, the one or more components include a decoder configured for determining additional information for the specimen from the information determined for the specimen, and the decoder is configured as a ViT or a Swin transformer. In addition, the DefectGPT decoder model may be any transformer-based model including, but not limited to, a transformer, ViT, hybrid CNN with transformer/ViT, CNN, and Swin transformer. The decoders described herein may also be further configured as described in the references incorporated above.

The setup procedure for the embodiments described herein may be performed in a variety of ways described herein. The training data inputs for Network A may include DOI location hints and DOI descriptors. The DOI location hints may be a binary map that represents the location of defects. The DOI descriptors include the feature attributes of DOIs (optics, process, tool condition, etc.). The ground truth for Network A can either be defects generated by a physical model or real defects.

The training data inputs for Network B include design images, optical modes, and process parameters. The design images represent the background pattern of optical images. Optical modes and process parameters are used for representing different optical modes and process parameters. The ground truth for Network B is the real optical images.

The training data inputs for Network C1 include defect signals generated by Network A and simulated images without defects generated by Network B. The ground truth for Network C1 may either be images with defects generated by a physical model or real optical images with defects.

The training data inputs for Network C2 include DOI latent generated by Network A and pattern latent generated by Network B. The ground truth for Network C2 can either be images with defects generated by a physical model or real optical images with defects.

The training steps may include initializing the parameters of the encoder backbone from scratch or ImageNet Pre-trained DefectGPT encoder. (The “backbone” refers to the network architecture in the DefectGPT encoder.) The best way to do this is through self-supervised learning, with the encoder backbone pre-trained on a relatively large group of wafer datasets. The encoder backbone can also be jointly learned with a defect detection model. The parameters of the decoder backbone can be initialized from scratch. In the general construction, the models described herein can be trained as follows: (1) Network A; (2) Network B; (3) Network C1 and/or Network C2. In the optimized construction, Network D can be trained directly (without Networks A, B, C1, and C2). Therefore, the training for the different options presented herein include (1) training Networks A, B, and C1, (2) training Networks A, B, and C2, (3) training Networks A, B, C1, and C2 (then selecting the best of C1 and C2 for inference performed with Networks A and B), and (4) training only Network D.

With respect to training Network C1 and/or Network C2, Network C1 and C2 are configured to have the same functionality with the same output. The difference between them is the input. Network C1 uses the output of Network A and B as input, and Network C2 uses the intermediate feature latent of Networks A and B as input. The embodiments described herein may train both Network C1 and Network C2, then compare the performance, and select the better model for inference.

In some embodiments, the pre-trained DefectGPT encoder is pre-trained once and thereby capable of determining different kinds of information from different kinds of the one or more inputs without additional training. For example, one of the most important advantages of the embodiments described herein is the ability to pre-train once and apply the embodiments to different semiconductor steps, physical IC designs, processes for defect detection or defect synthesis (vs. previously a different model must be trained for each step, physical IC design, or process). In addition, the pre-trained DefectGPT encoder in each of Networks A, B, C1, C2 and D for the defect synthesis embodiments as well as the defect detection embodiments may be the same. The architecture of the decoder in each of the networks configured for defect synthesis may also be the same, and it can be pre-trained or randomly initialized.

In another embodiment, the pre-trained DefectGPT encoder is configured for determining the information by synthesizing DOIs for more than one optical mode. For example, another advantage of the embodiments described herein is the ability to synthesize DOIs in a multi-optical mode context, with consideration of process condition and tool condition.

In a further embodiment, the pre-trained DefectGPT encoder is configured for determining the information by synthesizing a DOI distribution in a Bayesian perspective. For example, an important advantage of the embodiments described herein is the ability to synthesize DOI distribution in Bayesian perspective. Here, the Bayesian perspective refers to the fact that the simulated images from Network C1 and C2 can be an imaging distribution as opposed to a 2D matrix with one value at each location. An imaging distribution can be approximated by, for example, a multivariant Gaussian distribution or other multivariant 2D distributions.

In an additional embodiment, the pre-trained DefectGPT encoder is configured for determining the information by synthesizing a process noise distribution for more than one optical mode. For example, another advantage of the embodiments described herein is the ability to synthesize process noise distribution in a multi-optical mode context with consideration of process condition and tool condition. The process noise distribution may be generated by the Bayesian distribution described above as part of the covariant matrix or variant matrix. The models (e.g., Networks C1 and C2) are expected to predict the noise nature through Bayesian statistics.

In one embodiment, the one or more components include a decoder configured for generating synthesized defect information from the information determined for the specimen by the pre-trained DefectGPT encoder, and the computer subsystem is configured for training a defect detection model with the synthesized defect information. For example, the defect images generated by the embodiments described herein can be used to train AI-based detection models for optical inspection, such as the models described in U.S. Pat. No. 11,551,348 to Zhang et al. issued Jan. 10, 2023, and U.S. Patent Application Publication No. 2024/0013365 by Zhang et al. published Jan. 11, 2024, which are incorporated by reference as if fully set forth herein. The embodiments described herein may be further configured as described in these references. In another embodiment, the pre-trained DefectGPT encoder is jointly learned with a defect detection model, which may be performed in any suitable manner known in the art. In a further embodiment, the pre-trained DefectGPT encoder and a defect detection model are learned by supervised fine-tuning. For example, joint learning may be performed by directly training the pre-trained DefectGPT encoder and defect detection model or learning by supervised fine-tuning (SFT), which may be performed in any suitable manner known in the art.

In a further embodiment, the pre-trained DefectGPT encoder is configured for learning guided by a defect detection model via reinforcement learning. In other words, the DefectGPT model learning can be guided by a defect detection model, via reinforcement learning, which may be performed in any suitable manner known in the art.

In an additional embodiment, the pre-trained DefectGPT encoder is configured for determining the information for single mode or multiple mode optics conditions. Training an AI-based defect model for optical inspection with the defect images generated as described herein provides a number of benefits such as improving sensitivity of the defect detection model in single mode optical inspection and/or multiple mode optical inspection. Another benefit of such training is that it can improve defect discovery for out-of-distribution defects. Here, an out-of-distribution (OOD) defect refers to the possible defects that an application or customers expect to exist on a wafer, but are difficult to discover or identify through other means. Because these types of defects are not commonly available for downstream tasks like defect detection recipe setup, they are not part of the candidates or dataset during setup, and that is why they are OOD. By using the embodiments described herein, the proposed approach can simulate these “expected” defects and use them for the downstream tasks like training a defect detector. Then, the detector can be used to increase the chance to discover these OOD defects in practical experiments. An additional benefit is that such training can improve the generalizability of the AI detection model, e.g., among different wafers and/or different processes.

In another embodiment, the pre-trained DefectGPT encoder is configured for determining the information by jointly generating pattern and defect information for the specimen at the same time. For example, as described further herein, (1) the combination of Networks A, B, and C1, (2) the combination of Networks A, B, and C2, and (3) Network D can jointly generate pattern and defect information for a specimen at the same time.

In some embodiments, the pre-trained DefectGPT encoder is configured for determining the information for process variations, process conditions, and tool conditions. For example, the embodiments can consider any one or more of process variations, process conditions, and tool conditions.

In a further embodiment, the pre-trained DefectGPT encoder is configured for determining the information by determining a defect distribution. In another embodiment, the pre-trained DefectGPT encoder is configured for determining the information by determining a noise distribution. The defect and noise distributions may be determined as described further herein, e.g., in a Bayesian perspective or distribution.

In some embodiments, the computer subsystem is configured for pre-training an initial DefectGPT encoder without any real DOI examples (or with a limited number of real DOI examples) thereby producing the pre-trained DefectGPT encoder, and the computer subsystem is configured for detecting defects on the specimen, generating synthesized defect information, or a combination thereof based on the information determined for the specimen by the pre-trained DefectGPT encoder. For example, the embodiments described herein can work with zero or a limited number of real DOIs.

The computer subsystem may be configured for storing a variety of information, images, etc. generated by the embodiments described herein. For example, the computer subsystem may be configured for storing synthesized defect information, generated defect signal images, simulated images of the specimen with and/or without defects, etc. for use in training of a ML or DL model or network such as those described herein. In one such example, the computer subsystem may store such information and/or images in a training data structure or file. The information, images, etc. may be stored in any suitable manner and in any computer-readable storage medium described herein.

In another example, the computer subsystem may be configured for storing a DOI query embedding, synthesized defect information, generated defect signal images, simulated images of the specimen with and/or without defects, etc., a ML or DL model or network trained using any of such information, and the like for use during a process performed on the specimen such as those described herein. The computer subsystem may be configured to store such information and/or model or network in a recipe or by generating a recipe for the process in which the information and/or model or network will be used. A “recipe” as that term is used herein is defined as a set of instructions that can be used by a tool to perform a process on a specimen. In this manner, generating a recipe may include generating information for how a process is to be performed, which can then be used to generate the instructions for performing that process. The computer subsystem may also store any such information and/or model or network that can be used to identify, access, and/or use the information and/or model or network (e.g., such as a file name and where it is stored). The information for the model or network that is stored may also include the code, instructions, algorithms, etc. for the model or network. The information, model or network, etc. therefore may be stored in any suitable manner in any of the computer-readable storage media described herein.

The information, model or network, etc. may be stored with any of the other results described herein and may be stored in any manner known in the art. The storage medium may include any storage medium described herein or any other suitable storage medium known in the art. After the information has been stored, the information can be accessed in the storage medium and used by any of the method or system embodiments described herein, formatted for display to a user, used by another software module, method, or system, etc. For example, the embodiments described herein may generate an inspection recipe as described above. That inspection recipe may then be stored and used by the system or method (or another system or method) to inspect the specimen or other specimens to thereby generate information (e.g., defect information) for the specimen or other specimens. The computer subsystem may also be configured for detecting defects on a specimen as described herein, and information generated by the computer subsystem for the detected defects may be stored and used as described further herein.

Results and information generated by performing the inspection on the specimen or other specimens of the same type may be used in a variety of manners by the embodiments described herein and/or other systems and methods. Such functions include, but are not limited to, altering a process such as a fabrication process or step that was or will be performed on the inspected specimen or another specimen in a feedback or feedforward manner. For example, the computer subsystem may be configured to determine one or more changes to a process that was performed on a specimen inspected as described herein and/or a process that will be performed on the specimen based on the detected defect(s). The changes to the process may include any suitable changes to one or more parameters of the process. The computer subsystem preferably determines those changes such that the defects can be reduced or prevented on other specimens on which the revised process is performed, the defects can be corrected or eliminated on the specimen in another process performed on the specimen, the defects can be compensated for in another process performed on the specimen, etc. The computer subsystem may determine such changes in any suitable manner known in the art.

Those changes can then be sent to a semiconductor fabrication system (not shown) or a storage medium (not shown) accessible to the computer subsystem(s) and the semiconductor fabrication system. The semiconductor fabrication system may or may not be part of the system embodiments described herein. For example, the computer subsystem and/or inspection subsystem described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

As described herein, therefore, the embodiments can be used to setup a new inspection process or recipe. The embodiments may also be used to modify an existing inspection process or recipe, whether that is an inspection process or recipe that was used for the specimen or was created for one specimen and is being adapted for another specimen.

The embodiments described herein are not limited to inspection recipe or process creation or modification. For example, the embodiments described herein can also be used to setup or modify a recipe or process for metrology, defect review, etc. in a similar manner. In particular, the pre-trained DefectGPT encoder described herein can be trained depending on the process that is being setup or revised (e.g., to generate simulated outputs that mimic the actual outputs that would be generated by the process). Then, depending on the process or recipe that is being setup or altered, the simulated outputs may be used to setup a recipe for that process, whether that is storing synthetic information and/or simulated images that are used in the process or to train a DL or ML model or network for use in the process. Such output processing methods may include, for example, defect re-detection methods used for re-detecting defects in output generated by a defect review system.

In a similar manner, the embodiments described herein may be used to select not just output processing parameters and methods but also output acquisition parameters or modes, which with, for example, an inspection system, a metrology system, or a defect review system detects light, electrons, ions, etc. from a specimen. Such output acquisition parameter selection may include using the pre-trained DefectGPT encoder to generate simulated images for different output acquisition parameters or modes, which may be performed as described further herein. The generated simulated images can then be compared and evaluated to select which modes or parameters are the best for any one process. The embodiments described herein can therefore be used not just for setting up or modifying an inspection process but also for setting up or modifying any quality control type process performed on the specimens described herein and any parameters of such a process.

Each of the embodiments described above may be combined together into one single embodiment. In other words, unless otherwise noted herein, none of the embodiments are mutually exclusive of any other embodiments.

Another embodiment relates to a computer-implemented method for determining information for a specimen. The method includes inputting one or more inputs specific to a specimen into a pre-trained DefectGPT encoder configured for determining information for the specimen based on the one or more inputs. The inputting is performed by a computer subsystem. One or more components are executed by the computer subsystem, and the one or more components include the pre-trained DefectGPT encoder.

Each of the steps of the method may be performed as described further herein. The method may also include any other step(s) that can be performed by the inspection system and/or computer system described herein. In addition, the method described above may be performed by any of the system embodiments described herein.

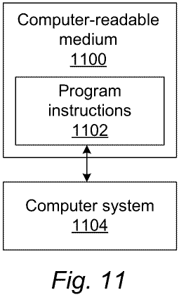

An additional embodiment relates to a non-transitory computer-readable medium storing program instructions executable on a computer system for performing a computer-implemented method for determining information for a specimen. One such embodiment is shown in FIG. 11. In particular, as shown in FIG. 11, non-transitory computer-readable medium 1100 includes program instructions 1102 executable on computer system 1104. The computer-implemented method may include any step(s) of any method(s) described herein.

Program instructions 1102 implementing methods such as those described herein may be stored on computer-readable medium 1100. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension), Python, Tensorflow, or other technologies or methodologies, as desired.

Computer system 1104 may be configured according to any of the embodiments described herein.

Further modifications and alternative embodiments of various aspects of the invention will be apparent to those skilled in the art in view of this description. For example, methods and systems for determining information for a specimen are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain attributes of the invention may be utilized independently, all as would be apparent to one skilled in the art after having the benefit of this description of the invention. Changes may be made in the elements described herein without departing from the spirit and scope of the invention as described in the following claims.

1. A system configured for determining information for a specimen, comprising:
a computer subsystem; and
one or more components executed by the computer subsystem, wherein the one or more components comprise a pre-trained defect generative pre-trained transformer (DefectGPT) encoder configured for determining information for a specimen based on one or more inputs specific to the specimen, and wherein the computer subsystem is configured for inputting the one or more inputs into the pre-trained DefectGPT encoder.

2. The system of claim 1, wherein the computer subsystem is further configured for detecting defects on the specimen based on the information determined for the specimen by the pre-trained DefectGPT encoder.

3. The system of claim 1, wherein the computer subsystem is further configured for pre-training an initial DefectGPT encoder thereby producing the pre-trained DefectGPT encoder, and wherein the pre-training is performed with a training dataset comprising images specific to the specimen and images that are unrelated to determining the information for the specimen based on the one or more inputs.

4. The system of claim 1, wherein the computer subsystem is further configured for pre-training an initial DefectGPT encoder thereby producing the pre-trained DefectGPT encoder, and wherein the pre-training is performed with a training dataset comprising only images specific to the specimen.

5. The system of claim 1, wherein the computer subsystem is further configured for pre-training an initial DefectGPT encoder thereby producing the pre-trained DefectGPT encoder, and wherein the initial DefectGPT encoder is configured for encoding input images into visual token embeddings.

6. The system of claim 1, wherein the computer subsystem is further configured for pre-training an initial DefectGPT encoder in a self-supervised manner thereby producing the pre-trained DefectGPT encoder.

7. The system of claim 1, wherein the pre-trained DefectGPT encoder is further configured for determining a defect of interest (DOI) query embedding based on one or more input DOI prompt images.

8. The system of claim 7, wherein the one or more inputs comprise a target image for defect detection, wherein determining the information comprises determining a visual token embedding for the target image, and wherein the computer subsystem is further configured for determining a measure of similarity between the DOI query embedding and the visual token embedding and determining if a defect is present in the target image based on the determined measure of similarity.

9. The system of claim 1, wherein the one or more components further comprise a decoder configured for generating synthesized defect information from the information determined for the specimen by the pre-trained DefectGPT encoder.

10. The system of claim 1, wherein the computer subsystem is further configured for generating fused DOI features from DOI location hints and DOI descriptors, wherein the one or more inputs comprise the fused DOI features, wherein the determined information comprises DOI embedding, and wherein the one or more components further comprise a decoder configured for generating defect signal images from the DOI embedding.

11. The system of claim 1, wherein the computer subsystem is further configured for generating fused pattern features from design images for the specimen, optical mode information, and process parameter information, wherein the one or more inputs comprise the fused patterned features, wherein the determined information comprises pattern embedding, and wherein the one or more components further comprise a decoder configured for generating simulated images of the specimen without defects from the pattern embedding.

12. The system of claim 1, wherein the computer subsystem is further configured for generating fused input from defect signal images for the specimen and simulated images without defects for the specimen, wherein the one or more inputs comprise the fused input, wherein the determined information comprises simulated embedding, and wherein the one or more components further comprise a decoder configured for generating simulated images with defects on the specimen from the simulated embedding.

13. The system of claim 1, wherein the determined information comprises DOI embedding, pattern embedding, and combined embedding generated from the DOI embedding and the pattern embedding, and wherein the one or more components further comprise a decoder configured for generating simulated images with defects on the specimen from the combined embedding.

14. The system of claim 1, wherein the one or more inputs comprise design images for the specimen, and wherein the one or more components further comprise a first diffusion process model configured for generating design embedding from the information determined for the specimen by the pre-trained DefectGPT encoder.

15. The system of claim 14, wherein the one or more components further comprise a condition encoder configured for determining additional information for the specimen from DOI location hints, DOI descriptors, optical mode information, and process parameter information, and wherein the one or more components further comprise a second diffusion process model configured for generating condition embedding from the additional information.

16. The system of claim 15, wherein the one or more components further comprise a decoder configured for generating simulated images with defects for the specimen based on the design embedding and the condition embedding.

17. The system of claim 1, wherein the pre-trained DefectGPT encoder is configured as a vision transformer (ViT) or a Swin transformer.

18. The system of claim 1, wherein the one or more components further comprise a decoder configured for determining additional information for the specimen from the information determined for the specimen, and wherein the decoder is configured as a vision transformer (ViT) or a Swin transformer.

19. The system of claim 1, wherein the pre-trained DefectGPT encoder is pre-trained once and thereby capable of determining different kinds of the information from different kinds of the one or more inputs without additional training.

20. The system of claim 1, wherein the pre-trained DefectGPT encoder is further configured for determining the information by synthesizing DOIs for more than one optical mode.

21. The system of claim 1, wherein the pre-trained DefectGPT encoder is further configured for determining the information by synthesizing a DOI distribution in a Bayesian perspective.

22. The system of claim 1, wherein the pre-trained DefectGPT encoder is further configured for determining the information by synthesizing a process noise distribution for more than one optical mode.

23. The system of claim 1, wherein the one or more components further comprise a decoder configured for generating synthesized defect information from the information determined for the specimen by the pre-trained DefectGPT encoder, and wherein the computer subsystem is further configured for training a defect detection model with the synthesized defect information.

24. The system of claim 1, wherein the pre-trained DefectGPT encoder is further configured for determining the information by jointly generating pattern and defect information for the specimen at the same time.

25. The system of claim 1, wherein the pre-trained DefectGPT encoder is further configured for determining the information for single mode or multiple mode optics conditions.

26. The system of claim 1, wherein the pre-trained DefectGPT encoder is further configured for determining the information for process variations, process conditions, and tool conditions.

27. The system of claim 1, wherein the pre-trained DefectGPT encoder is further configured for determining the information by determining a defect distribution.

28. The system of claim 1, wherein the pre-trained DefectGPT encoder is further configured for determining the information by determining a noise distribution.

29. The system of claim 1, wherein the computer subsystem is further configured for pre-training an initial DefectGPT encoder without any real DOI examples thereby producing the pre-trained DefectGPT encoder, and wherein the computer subsystem is further configured for detecting defects on the specimen, generating synthesized defect information, or a combination thereof based on the information determined for the specimen by the pre-trained DefectGPT encoder.

30. The system of claim 1, wherein the computer subsystem is further configured for pre-training an initial DefectGPT encoder with a limited number of real DOI examples thereby producing the pre-trained DefectGPT encoder, and wherein the computer subsystem is further configured for detecting defects on the specimen, generating synthesized defect information, or a combination thereof based on the information determined for the specimen by the pre-trained DefectGPT encoder.

31. The system of claim 1, wherein the pre-trained DefectGPT encoder is jointly learned with a defect detection model.

32. The system of claim 1, wherein the pre-trained DefectGPT encoder and a defect detection model are learned by supervised fine-tuning.

33. The system of claim 1, wherein the pre-trained DefectGPT encoder is further configured for learning guided by a defect detection model via reinforcement learning.

34. A non-transitory computer-readable medium, storing program instructions executable on a computer system for performing a computer-implemented method for determining information for a specimen, wherein the computer-implemented method comprises:
inputting one or more inputs specific into a specimen to a pre-trained DefectGPT encoder configured for determining information for the specimen based on the one or more inputs.

35. A computer-implemented method for determining information for a specimen, comprising:
inputting one or more inputs specific to a specimen into a pre-trained DefectGPT encoder configured for determining information for the specimen based on the one or more inputs, wherein said inputting is performed by a computer subsystem, wherein one or more components are executed by the computer subsystem, and wherein the one or more components comprise the pre-trained DefectGPT encoder.
